(19) United States
(12) Patent Application Publication
(10) Pub. No.: US 2023/0018298 A1
(43) Pub. Date: Jan. 19, 2023

(54) SYSTEMS AND METHODS OF MAINTAINING ENERGY ALLOCATION FOR A COMMUNITY SOLAR ENERGY GENERATING SYSTEM

(71) Applicant: Arcadia Power, Inc., Washington, DC (US)

(72) Inventors: Richard Caperton, Washington, DC (US); Madeline Rossman, Chicago, IL (US); Rachel Partridge, Arlington, VA (US); Ryan Sandridge, Arlington, VA (US); Stephen Peyton, Denver, CO (US); Samantha Kane, Arlington, VA (US)

(21) Appl. No.: 17/374,166

(22) Filed: Jul. 13, 2021

(51) Int. Cl. G06Q 30/00; G06Q 30/02; G06Q 50/06; G06F 16/23; H02J 3/38

(52) U.S. Cl. CPC G06Q 30/016; G06Q 30/0201; G06Q 50/06; G06F 16/2379; H02J 3/381; G06Q 40/12

(57) ABSTRACT

Implementations of the disclosed subject matter may provide a method of receiving utility account information of an energy utility for a customer that is also enrolled with a community solar energy generating system. The customer may have a first account and a first allocation of energy with the community solar energy generating system. The address information for the customer is scraped from the received utility account information. When it is determined that the address information of the utility account is different from the address information of the first account, the customer may be enrolled a second account with the community solar energy generating system using the scraped address information. A second allocation of energy for the second account may be provided that is the same as the first allocation of energy from the community solar energy generating system, and the first account may be subsequently closed.

### BACKGROUND

Presently, customers in certain utility territories are able to subscribe to the energy generated by a community solar project separate from their traditional energy distribution company and/or supplier, such as a utility company. Customers who separately subscribe to a community solar project receive separate bills, along with separate information regarding energy consumption or usage, and energy generation of the renewable energy source. Frequently, it can be difficult for customers to determine what savings, environmental impacts, or the like their subscription to a community solar project is providing. In addition, because the subscription is distinct from their utility account, customers and community solar projects struggle to maintain their relationship if customers change residences.

### BRIEF SUMMARY

According to an implementation of the disclosed subject matter, a method may be provided for receiving, at a server, utility account information from an energy utility for a customer that is also enrolled with a community solar energy generating system. The customer may have a first account and a first allocation of energy with the community solar energy generating system. The utility account information may include at least address information of the customer. The server may scrape the address information for the customer from the received utility account information. The server may determine whether the scraped address information of the utility account is different from address information of the first account of the customer that is enrolled with the community solar energy generating system. The server may enroll the customer in a second account with the community solar energy generating system using the scraped address information when it is determined that the address information of the utility account is different from the address information of the first account. The server may allocate a second allocation of energy for the second account that is the same as the first allocation of energy from the community solar energy generating system. The server may close the first account of the customer enrolled with the community solar energy generating system.

According to an implementation of the disclosed subject matter, a system may be provided that includes a server having a processor, and a storage device communicatively coupled to the server. The server may receive utility account information from an energy utility for a customer that is also enrolled with a community solar energy generating system. The customer may have a first account and a first allocation of energy with the community solar energy generating system. The utility account information may include at least address information of the customer. The server may scrape the address information for the customer from the received utility account information. The server may determine whether the scraped address information of the utility account is different from address information of the first account of the customer that is enrolled with the community solar energy generating system. The server may enroll the customer in a second account with the community solar energy generating system using the scraped address information when it is determined that the address information of the utility account is different from the address information of the first account. The server may allocate a second allocation of energy for the second account that is the same as the first allocation of energy from the community solar energy generating system. The server may close the first account of the customer enrolled with the community solar energy generating system.

Additional features, advantages, and implementations of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example method of maintaining energy allocation for a community solar energy generating system when a customer changes addresses according to an implementation of the disclosed subject matter.

FIG. 2 shows a network arrangement of energy generating systems, servers, databases, and customer devices according to an implementation of the disclosed subject matter.

FIG. 3 shows an example database structure for a database according to an implementation of the disclosed subject matter.

FIG. 4 shows a customer's device that may interface with the network arrangement shown in FIG. 2 according to an implementation of the disclosed subject matter.

### DETAILED DESCRIPTION

Implementations of the disclosed subject matter provide systems and methods for maintaining an allocation of electrical output for subscriptions to a community solar energy generating system when a customer moves and/or changes an address. The disclosed subject matter may improve the efficiency of the allocation of the electrical output of the community solar energy generating system by avoiding the loss and/or inefficient allocation of the electrical output generated by the system.

The disclosed systems and methods provide automatic retention of one or more services of a customer of a third-party aggregator of energy services, including a community solar energy generating system, when the customer moves and changes an address. A customer of an aggregator account with the third-party aggregator may have a subscription to a community solar energy generating system, a traditional electric utility, a subscription to a wind power generation system, or the like. The third-party aggregator may provide a single bill to the customer of the aggregator account, which provides a statement and/or invoice to the customer for all services and/or credits received (e.g., electricity from a traditional utility, electricity from a community solar energy generating system, electricity from a wind power generation system, or the like).

Implementations of the disclosed subject matter may determine when one or more utility accounts that are separate from the subscription to community solar energy generating system but are associated with the same customer aggregator account have an address change and/or a new utility account associated with the customer. When the new address and/or new utility account is determined by the third-party aggregator, a new aggregator account may be created for the customer with the same utility account and/or product enrollments, including enrollment with the community solar energy generating system. When the new aggregator account has been created, systems and methods of the disclosed subject matter may automatically close old subscription accounts for the community solar energy generating system, old product and/or service accounts (e.g., for wind power generation systems, or the like), old aggregator accounts, and the like.

That is, implementations of the disclosed subject matter provide systems and methods that allow customers to seamlessly retain a subscription to the community solar energy generating system when the customer moves. The customer may provide access to information from one or more separate utility accounts (e.g., traditional electricity account or the like). A server (e.g., of the third-party aggregator) may use a scraper on information received from one or more of the utility accounts to determine if any new utility accounts have been created (e.g., that include a new address), and may create a new subscription account for the community solar energy generating system in order to maintain the customer's enrollment and the electricity allocation for the community solar energy generating system, along with a new aggregator account that includes the new subscription, the new utility account, and/or any other product and/or service accounts.

Implementations of the disclosed subject matter may detect when a customer is moving and/or has changed an address, and may determine the customer's new utility account. The newly discovered utility account may be automatically enrolled in the customer's new aggregator account, along with other products and services (e.g., a subscription to the community solar energy generating system, and the like). After the new subscription account for the community solar energy generating system is created for the customer, the customer's previous subscription account for community solar energy generating system with the customer's previous address may be closed and/or removed. The old aggregator account may be closed, for example, after the closing of the subscription account for community solar energy generating system.

When a user moves and starts service for a utility account in a new home and/or at a new address, the server (e.g., of the third-party aggregator) may detect the new account and/or address, and may create a new aggregator account with, for example, the same set of product enrollments as the customer's original aggregator account, which may include the subscription to the community solar energy generating system. This may maintain the integration of electricity services, such that the customer enrolled with a utility account and a subscription to the community solar energy generating system need not take any action in order to stay enrolled in these services.

In current systems, a customer initiates a change of address or change of subscription account for the community solar energy generating system based on the customer's new address, and typically provide a plurality of documents that include personal information to facilitate the change in the subscription service. Currently, the subscription service must manually create a new account for the customer, and individually re-enroll the customer in all services for their new account. In current systems, if the customer fails to initiate the change of address, electrical power from the community solar energy generating system needs to be reallocated to other customers. Until the reallocation is performed, energy produced by the community solar energy generating system that is unallocated may be wasted or inefficiently used.

Traditionally, home energy services are tightly coupled with a customer's home, and moving means either giving up the service or needing to transfer the service to the new home, which can often be time consuming. Implementations of the disclosed subject matter provide systems and methods that retain the subscription of the customer to a community solar energy generating system so that electrical power generated by the energy generating system does not have to be reallocated, wasted, and/or inefficiently used.

That is, implementations of the disclosed subject matter increase the efficiency of community solar energy generating systems by avoiding the inefficient allocation of the energy generated by the project. Community solar energy generating systems typically allocate economic credits to subscribers based on the energy generated by the project. A community solar energy generating system obtains the full value of the allocated energy when the community solar energy generating system is fully subscribed, meaning that the entire energy output in a predetermined period of time (e.g., one month, three months, six months or the like) is allocated to a subscriber or group of subscribers. If a customer's subscription to the community solar energy generating system is cancelled or disrupted (e.g., due to the customer moving), the community solar energy generating system would need to replace that customer. Delays in obtaining a new customer may cause the community solar energy generating system to generate energy that is not allocated to any customer, and/or to lose the value of the energy it produces.

Disruption of service due to a move by the customer may impose economic costs on both solar developers (i.e., the owners of the community solar energy generating system) and solar service allocation entities. Community solar energy generating systems are typically entitled to state or other governmental entity regulated revenue opportunities if the energy generated is allocated to subscribers in a predetermined time period (e.g., a month) is physically produced and provided to the electric grid. If the subscriber's account is not successfully moved, the account's share of electricity produced by the community solar energy generating system solar production may be considered “unsubscribed.” Unsubscribed energy may be defined as energy generated and fed into the electrical grid, but energy that would not be able to participate the state and/or government incentives. Non-participation may result in significant detrimental impacts. For example, the solar developer may not receive payment for electricity it provides to the grid via the community solar energy generating system. If the solar developer does receive payment, it may be from the utility at a reduced rate than the customer would pay. In another example, third-party aggregator companies that manage subscriptions and billing for customers of the community solar energy generating system and utility accounts may not be able to receive fees from solar developers with respect to the capacity that is lost. In another example, bill credits from the community solar energy generating system may have an economic value. Disruption of service by the customer moving may leave such credits unassigned, and the credits may be lost.

Disruption of a service due to a move may harm the customer, as there may be a delay between when the customer moves, and when the customer may be re-enrolled (i.e., re-subscribed) with the community solar energy generating system. For example, the community solar energy generating system may not have availability at the time that the customer attempt to re-subscribe, as they may have taken on additional customers and/or reallocated the energy generated by the community solar energy generating system.

As discussed above, when the customer moves and there is a service disruption, the disruption may impact the community solar energy generating system, the customer, and/or the third-party aggregator who manages the customer's aggregator account that includes the subscription to the community solar energy generating system.

The costs and losses in the example described above typically preclude them from being re-assigned or redeemed in the future, which results in an economically valuable asset being lost to waste. Moreover, when a customer who does not create a new subscription account for the community solar energy generating system when the customer moves may adversely change the associated electricity demand from the community solar energy generating system and the economic stability of such a system.

The costs, along with attrition of subscribers, may disincentivize solar developers. These factors may be an obstacle to building new solar energy projects. Subscriber fees are typically the primary source of revenue for a community solar energy generating system, so any loss and/or inefficiencies with respect to customer retention may be important in the planning process for a developer.

Implementations of the disclosed subject matter as described throughout may decrease energy waste, lost revenue, and/or subscriber attrition associated with user moves. Further, the disclosed subject matter may preserve and/or maintain customers, as well as allocations for electrical energy generated by community solar energy generating system. That is, there may be no reallocation of energy and/or waste of energy.

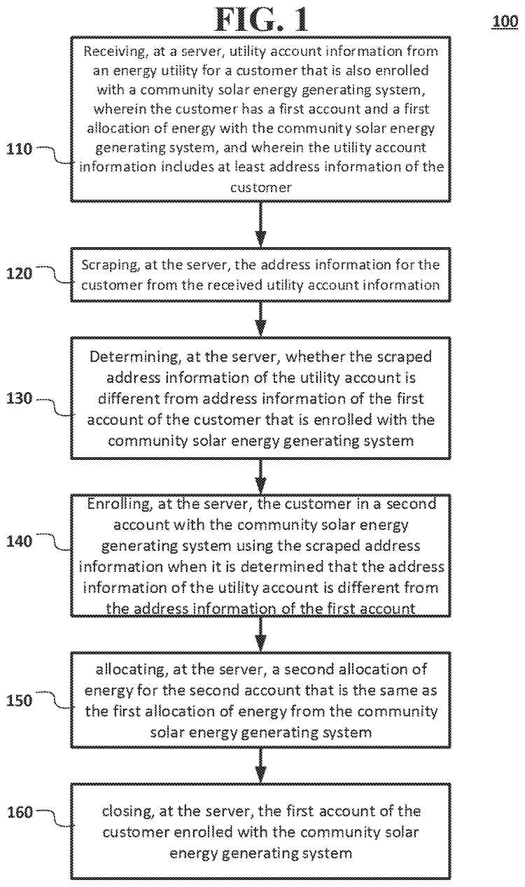

FIG. 1 shows an example method 100 of maintaining energy allocation for a community solar energy generating system when a customer changes an address according to an implementation of the disclosed subject matter.

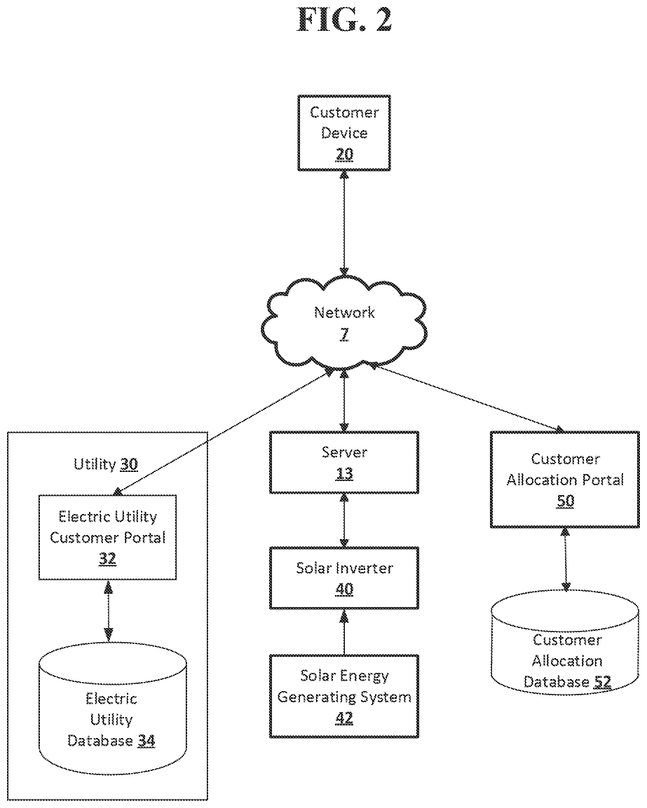

The customer may initiate a utility account with a traditional electrical utility (e.g., utility 30 shown in FIG. 2) to provide electricity to their home. In some implementations, the customer may initiate the utility account using with device 20 by communicating with electric utility customer portal 32 of the utility 30. The customer's utility account may be generated by utility 30 and/or electric utility customer portal 32, and may be stored in electric utility database 34. The customer may obtain a subscription to a community solar energy generating system (e.g., solar energy generating system 42), which may provide an allocation of electricity generated to the customer's home when the customer is eligible to receive a subscription (e.g., based on availability of generated output by the solar energy generating system 42 and the energy profile of the customer, and the like). The customer may request an account with a third-party aggregator (e.g., customer allocation portal 50 shown in FIG. 2), which may manage and/or aggregate billing for the customer's utility account, the customer's subscription to the community solar energy generating system, and/or any other products and/or services (e.g., a subscription to a wind power generation system, or the like). The customer's account with the third-party aggregator may be referred to as an aggregator account. The aggregator account may be stored in customer allocation database 52, shown in FIG. 2. The aggregator account may include address information and/or account information for the utility account, subscription to the community solar energy generating system, and/or any other account information for products and/or services.

At operation 110, a server of a customer allocation portal (e.g., customer allocation portal 50 shown in FIG. 2 and described below) may receive utility account information of an energy utility. The server of the customer allocation portal may be a server for a third-party aggregator, which may create and/or manage an aggregator account for a customer. As described above, the aggregator account may include information for the customer's utility account, the subscription to the community solar energy generating system, and/or other products and/or services (e.g., a subscription to a wind power generation system, or the like). The customer's aggregator account information may be stored in the customer allocation database 52 shown in FIG. 2.

For example, the utility account information may be received from electric utility customer portal 32 and/or electric utility database 34 of utility 30 shown in FIG. 2. The customer having the account with the energy utility may also be enrolled with a community solar energy generating system. For example, community solar energy generating system may be the solar energy generating system 42 shown in FIG. 2. The customer may have a first account and a first allocation of energy with the community solar energy generating system. The utility account information may include at least address information of the customer. In some implementations, the utility account information may include one or more services that the customer is subscribed to, billing information for the utility account, and the like. The customer's aggregate account (e.g., at the customer allocation portal 50 and/or the customer allocation database 52) may include the first account and first allocation energy for the community solar energy generating system.

At operation 120, the server may scrape the address information for the customer from the received utility account information. For example, as shown in FIG. 2, the server of the customer allocation portal 50 may scrape the address information received from the utility 30. In some implementations, the scraping may include, for example, extraction and/or separation of address information from the received utility account information.

At operation 130, the server may determine whether the scraped address information of the utility account is different from address information of the first account of the customer that is enrolled with the community solar energy generating system. That is, the address from the receive utility information may be compared to the address for the customer that is subscribed to the community solar energy generating system. The address of the first account of the customer with the community solar energy generating system may be stored in the customer allocation database 52 shown in FIG. 2 as part of the customer's aggregator account. The server of the customer allocation portal 50 may compare the scraped address information received from the utility 30 shown in FIG. 2 with the address of the customer stored in the customer's aggregator account in the customer allocation database 52.

In some implementations, the operations of receiving the utility account information at operation 110, the scraping the address information for the customer at operation 120, and the determining whether the scraped address information of the utility account is different from address information of the first account of operation 130 may be performed periodically. That is, the operations 110, 120, and 130 described above may be performed at a first predetermined time interval to determine whether the customer of the community solar energy generating system has changed addresses.

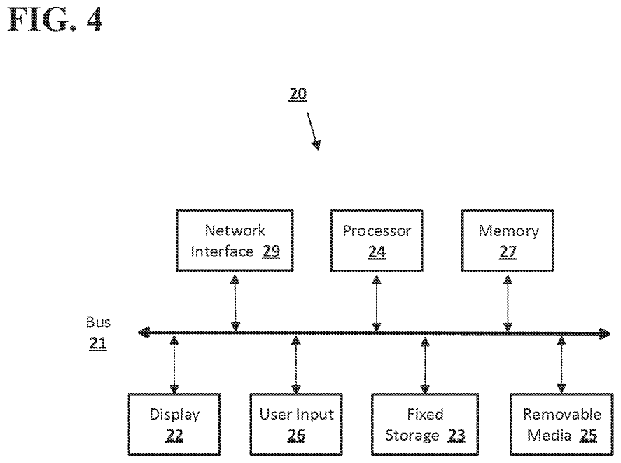

In some implementations, the server (e.g., the customer allocation portal 50 shown in FIG. 2, which may be the server for the third-party aggregator) may receive a change of address information from the customer. The customer may use device 20 as shown in FIGS. 2 and 4 to access a dashboard provided by the customer allocation portal 50. The dashboard may be a user interface that may be displayed, for example, on display 22 of device 20 shown in FIGS. 2 and 4, which may be communicatively coupled to the customer allocation portal 50. In this example implementation, the receiving the utility account information at operation at operation 110, the scraping the address information for the customer at operation 120, and the determining whether the scraped address information of the utility account is different from address information of the first account of operation 130 may be performed periodically at the server at a second predetermined time interval. This second predetermined time interval may be shorter than the first predetermined time interval described above. That is, the time interval (i.e., the second predetermined time interval) may be shorter when the customer provides a change of address notification using the dashboard. The server may scrape data at an increased frequency to obtain the change of address for the customer.

In some implementations, the server (e.g., a server of the customer allocation portal 50 shown in FIG. 2) may determine whether the utility account information includes a final bill for the customer from the energy utility (e.g., from the utility account information from utility 30 received at operation 110). The server may scrape the address information (e.g., at operation 130 described above) for the customer from the final bill of the received utility account information.

At operation 140, the server may enroll the customer in a second account with the community solar energy generating system using the scraped address information when it is determined that the address information of the utility account is different from the address information of the first account. For example, as shown in FIG. 2, the server of the customer allocation portal 50 may enroll the customer with the solar energy generating system 42, when it is determined that the address information of the utility account with the utility 30 is different from the address information of the first account of the solar energy generating system 42. In some implementations, the server may provide one or more services to the customer with the second account that are the same as one or more services provided to the customer with the first account before the closing of the first account. That is, the server, which may be the server for a third-party aggregator, may create a new aggregator account that includes the second account for the customer for the community solar energy generating system, the customer's utility account, and/or any other product and/or service accounts (e.g., a subscription to a wind power generation system, or the like).

At operation 150, the server may allocate a second allocation of energy for the second account that may be the same as the first allocation of energy from the community solar energy generating system. For example, the server of the customer allocation portal 50 (e.g., which may be the server for the third-party aggregator) may allocate energy generated by the solar energy generating system 42 to the second (i.e., new) account of the customer that is the same as the previous allocation. The second allocation of energy may be stored, along with other customer account information, at the customer allocation database 52. In some implementations, the server may store the second allocation of energy for the customer of the community solar energy generating system with the customer's aggregator account.

At operation 160, the server (e.g., the server for the customer allocation portal 50 shown in FIG. 2) may close the first account of the customer enrolled with the community solar energy generating system. That is, the first account may be stored in customer allocation database 52 shown in FIG. 2 may be closed by the customer allocation portal 50. In some implementations, the server may close the first account when an account of the energy utility of the customer that has an address that matches the address information of the first account is closed. In some implementations, when a new aggregator account is created for the customer with the second account for the community solar energy generating system, the new utility account of the customer, and/or any other product and/or service account, the server may close the customer's earlier aggregator account.

In some implementations, the server may transmit a message that the customer has been enrolled in the second account and the first account has been closed. For example, the customer allocation portal 50 may transmit a message via network 7 to the customer device 20. In some implementations, the server may transmit a message to the customer that the new aggregator account has been created that includes the customer's second account with the community solar energy generating system, the new utility account of the customer, and/or any other product and/or service account that was part of the customer's earlier aggregator account.

In implementations of the disclosed subject matter, the server may maintain the energy allocation for all enrolled customers of the solar energy generating system when one or more customers move. That is, by enrolling the customer that is moving in a second account, the server may maintain the energy allocation for the customer, and then may proceed to close the first account of the user.

FIG. 2 shows a network arrangement of energy generating systems, servers, databases, and customer devices according to an implementation of the disclosed subject matter. A utility 30 (i.e., an electric utility) may generate electricity to be provided to one or more customers via a power grid. The utility 30 may include a server that provides an electric utility customer portal 32, which may allow customers and/or a server of the customer allocation portal 50 to access account information with the utility 30. Account information may include, for example, utility bills, payment information, amount of energy used, address and contact information, and the like. The server of the utility 30 may be one or more hardware servers and or a cloud server. The server of the utility 30 that provides the electric utility customer portal 32 may be communicatively coupled to an electric utility database 34, which may store, among other things, historic utility bill statements, address information, account information, and the like for one or more customers. The utility 30 may be communicatively coupled to the server 13 via communications network 7.

The server 13 may be one or more hardware servers, cloud servers or the like, and may be connected to a solar inverter 40, and a solar energy generating system 42 (i.e., the community solar energy generating system). The solar inverter 40 may convert direct current (DC) output of a photovoltaic (PV) solar panels of the solar energy generating system 42 into an alternating current (AC) that may be provided into a commercial electrical grid, which may be the same power grid that the utility 30 is connected to. The solar inverter 40 may include a server (e.g., one or more hardware servers, a cloud server, or the like) to provide data logging and/or an application program interface (API). The data logger may determine the amount of energy generated by the solar energy generating system 42 over a predetermined period of time (e.g., one or more hours of the day, the amount of energy generated for one or more months, the amount of energy generated over a year, or the like). The API may provide at least a portion of the logged data to the server 13 and/or the customer device 20, and may be used to update (e.g., add, remove, or the like) customers that may be subscribed to the community solar energy generating system.

Customer allocation portal 50 may be provided by a server (e.g., one or more hardware servers, a cloud server, or the like), which may be communicatively coupled to customer allocation database 52. The customer allocation portal 50 may be for the third-party aggregator, which may manage subscriptions and/or billing for a customer having a subscription with the community solar energy generating system, a utility account, and/or other product and/or service accounts. The allocation portal 50 may be accessed, for example, by the server 13 to set and/or adjust an allocation of the energy for a customer that is subscribed to the community solar energy generating system. The set and/or adjusted allocation for a customer may be stored in the customer allocation database 52.

The utility 30, the server 13, the customer allocation portal 50, and a customer device 20 (described below in connection with FIG. 7) may be communicatively connected via communications network 7. The network 7 may be a local network, wide-area network, the Internet, or any other suitable communication network or networks, and may be implemented on any suitable platform including wired and/or wireless networks.

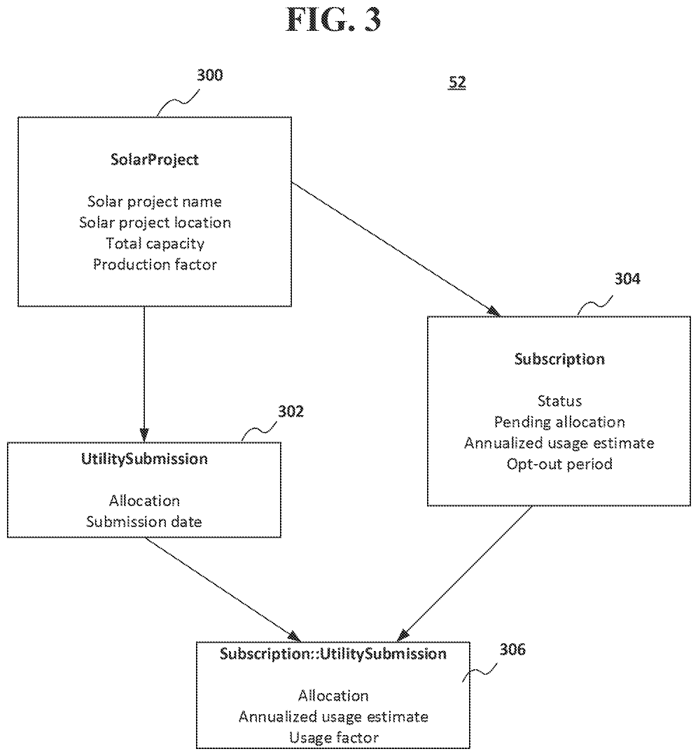

FIG. 3 shows a management data model that is stored in a database (e.g., customer allocation database 52 shown in FIG. 2) to track submission of customer allocations to a utility (e.g., utility 30 shown in FIG. 2) and/or rolling allocations by the customer allocation portal 50. The data structure 300 (i.e., SolarProject) may be for a solar energy project (i.e., a community solar energy generating system to be built or presently in operation, such as solar energy generating system 42 shown in FIG. 2), that may include the name of the project, the location of the project, the total energy-generating capacity of the project, and a production factor. The production factor may be a measure of how much energy is generated per unit of system capacity, and may be expressed in kWh/kW (e.g., where kWh is the energy output, and kW is the capacity). The data structure 302 (i.e., UtilitySubmission) may include an energy allocation for the solar energy project (e.g., a community solar energy generating system), and a submission date of the allocation to a utility (e.g., utility 30 shown in FIG. 2). The data structure 304 (i.e., Subscription) may include a status of a customer (e.g., active, awaiting allocation, discontinued service, or the like), a pending energy allocation amount of the customer, an annualized usage estimate (e.g., an estimate historic energy usage rate), and a length of an opt-out period (e.g., the length of time that the customer has to respond to a notification to accept or decline to receive energy generated by the community solar energy generating system). The data structure 306 (i.e., Subscription::UtilitySubmission) may include the determined allocation of energy for the customer, the annualized usage estimate of energy usage for the customer, and a usage factor (as described above).

In some implementations, the customer allocation portal 50 shown in FIG. 2 may transmit a list of the one or more of the plurality of customers and the respective allocations of energy to a utility (e.g., utility 30 shown in FIG. 2). The utility may assign an allocation of energy for each of the one or more of the plurality of customers based on the transmitted allocations from the customer allocation portal 50. The allocations for each customer may be stored in customer allocation database 52 shown in FIG. 2.

The customer allocation portal 50 may dynamically track energy allocation to one or more of the plurality of customers. The customer allocation portal 50 may transmit, via the communications network (e.g., communications network 7 shown in FIG. 2), the dynamically tracked energy usage for each of the one of more of the plurality of customers for display.

Embodiments of the presently disclosed subject matter may be implemented in and used with a variety of component and network architectures. FIG. 4 is an example customer device 20 that may a desktop or laptop computer, or a mobile computing device such as a smart phone, tablet, wearable computing device, or the like. In some implementations, the device 20 may be used to manage a subscription to the community solar energy generating system, to manage an account with the utility 30, to provide a notification to the customer allocation portal 50 regarding a change in address, and/or receive billing information from the customer allocation portal 50. The device 20 may include a bus 21 which interconnects major components of the device 20, such as a central processor 24, a memory 27 such as Random Access Memory (RAM), Read Only Memory (ROM), flash RAM, or the like, a user display 22 such as a display screen, a user input interface 26, which may include one or more controllers and associated user input devices such as a keyboard, mouse, touch screen, and the like, a fixed storage 23 such as a hard drive, flash storage, and the like, a removable media component 25 operative to control and receive an optical disk, flash drive, and the like, and a network interface 29 operable to communicate with one or more remote devices via a suitable network connection.

The bus 21 allows data communication between the central processor 24 and one or more memory components, which may include RAM, ROM, and other memory, as previously noted. Typically RAM is the main memory into which an operating system and application programs are loaded. A ROM or flash memory component can contain, among other code, the Basic Input-Output system (BIOS) which controls basic hardware operation such as the interaction with peripheral components. Applications resident with the device 20 are generally stored on and accessed via a computer readable medium, such as a hard disk drive (e.g., fixed storage 23), an optical drive, floppy disk, or other storage medium.

The fixed storage 23 may be integral with the device 20 or may be separate and accessed through other interfaces. The network interface 29 may provide a direct connection to a remote server via a wired or wireless connection. The network interface 29 may provide such connection using any suitable technique and protocol as will be readily understood by one of skill in the art, including digital cellular telephone, WiFi, Bluetooth®, near-field, and the like. For example, the network interface 29 may allow the computer to communicate with other computers via one or more local, wide-area, or other communication networks, as described in further detail below.

Many other devices or components (not shown) may be connected in a similar manner (e.g., sensors, energy use monitors, and the like). Conversely, all of the components shown in FIG. 4 need not be present to practice the present disclosure. The components can be interconnected in different ways from that shown. The operation of the device 20 such as that shown in FIG. 4 is readily known in the art and is not discussed in detail in this application. Code to implement the present disclosure can be stored in computer-readable storage media such as one or more of the memory 27, fixed storage 23, removable media 25, or on a remote storage location.

More generally, various implementations of the presently disclosed subject matter may include or be embodied in the form of computer-implemented processes and apparatuses for practicing those processes. Implementations also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing implementations of the disclosed subject matter. Implementations also may be embodied in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing implementations of the disclosed subject matter. When implemented on a general-purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that embodies all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method comprising:
receiving, at a server, utility account information from an energy utility for a customer that is also enrolled with a community solar energy generating system, wherein the customer has a first account and a first allocation of energy with the community solar energy generating system, and wherein the utility account information includes at least address information of the customer;
scraping, at the server, the address information for the customer from the received utility account information;
determining, at the server, whether the scraped address information of the utility account is different from address information of the first account of the customer that is enrolled with the community solar energy generating system;
enrolling, at the server, the customer in a second account with the community solar energy generating system using the scraped address information when it is determined that the address information of the utility account is different from the address information of the first account;
allocating, at the server, a second allocation of energy for the second account that is the same as the first allocation of energy from the community solar energy generating system; and
closing, at the server, the first account of the customer enrolled with the community solar energy generating system.

2. The method of claim 1, wherein the receiving the utility account information, the scraping the address information for the customer, and the determining whether the scraped address information of the utility account is different from address information of the first account are performed periodically at the server at a first predetermined time interval to determine whether the customer has changed addresses.

3. The method of claim 2, wherein the receiving the utility account information comprises:
receiving, at the server, a change of address information from the customer,
wherein the receiving the utility account information, the scraping the address information for the customer, and the determining whether the scraped address information of the utility account is different from address information of the first account are performed periodically at the server at a second predetermined time interval that is shorter than the first predetermined time interval.

4. The method of claim 1, wherein the receiving the utility account information comprises:
determining, at the server, whether the utility account information includes a final bill for the customer from the energy utility.

5. The method of claim 4, wherein the scraping comprises:
scraping, at the server, the address information for the customer from the final bill of the received utility account information.

6. The method of claim 1, further comprising:
transmitting, at the server, a message that the customer has been enrolled in the second account and the first account has been closed.

7. The method of claim 1, wherein the closing the first account of the customer comprises:
closing, at the server, the first account when an account of the energy utility of the customer that has an address that matches the address information of the first account is closed.

8. The method of claim 1, wherein the enrolling comprises:
providing at the server, one or more services to the customer with the second account that are the same as one or more services provided to the customer with the first account before the closing of the first account.

9. The method of claim 1, further comprising:
maintaining, at the server, the energy allocation for all enrolled customers of the solar energy generating system when the customer is enrolled in the second account and the first account is closed.

10. A system comprising:
a server having a processor, and a storage device communicatively coupled to the server to:
receive utility account information from an energy utility for a customer that is also enrolled with a community solar energy generating system, wherein the customer has a first account and a first allocation of energy with the community solar energy generating system, and wherein the utility account information includes at least address information of the customer;
scrape the address information for the customer from the received utility account information;
determine whether the scraped address information of the utility account is different from address information of the first account of the customer that is enrolled with the community solar energy generating system;
enroll the customer in a second account with the community solar energy generating system using the scraped address information when it is determined that the address information of the utility account is different from the address information of the first account;
allocate a second allocation of energy for the second account that is the same as the first allocation of energy from the community solar energy generating system; and
close the first account of the customer enrolled with the community solar energy generating system.

11. The system of claim 10, wherein the server receives the utility account information, scrapes the address information for the customer, and determines whether the scraped address information of the utility account is different from address information of the first account periodically at a first predetermined time interval to determine whether the customer has changed addresses.

12. The system of claim 11, wherein the server receives the utility account information by receiving a change of address information from the customer, and
wherein the server receives the utility account information, scrapes the address information for the customer, and determines whether the scraped address information of the utility account is different from address information of the first account are performed periodically at a second predetermined time interval that is shorter than the first predetermined time interval.

13. The system of claim 10, wherein the server receives the utility account information and determines whether the utility account information includes a final bill for the customer from the energy utility.

14. The system of claim 13, wherein the server scrapes the address information for the customer from the final bill of the received utility account information.

15. The system of claim 10, wherein the server transmits a message that the customer has been enrolled in the second account and the first account has been closed.

16. The system of claim 10, wherein the server closes the first account of the customer when an account of the energy utility of the customer that has an address that matches the address information of the first account is closed.

17. The system of claim 10, wherein the server enrolls the customer in the second account and provides one or more services to the customer with the second account that are the same as one or more services provided to the customer with the first account before the closing of the first account.

18. The system of claim 10, wherein the server maintains the energy allocation for all enrolled customers of the solar energy generating system when the customer is enrolled in the second account and the first account is closed.
